(19) United States
(12) Patent Application Publication
(10) Pub. No.: US 2026/0360041 A1
(43) Pub. Date: Nov. 12, 2026

(54) STORAGE MEDIUM, INFORMATION PROCESSING APPARATUS, AND METHOD OF CONTROLLING INFORMATION PROCESSING APPARATUS

(71) Applicant: CANON KABUSHIKI KAISHA, Tokyo (JP)

(72) Inventor: SATORU ODERA, Tokyo (JP)

(21) Appl. No.: 19/639,431

(22) Filed: Apr. 6, 2026

(30) Foreign Application Priority Data
May 7, 2025 (JP) 2025-077274

(51) Int. Cl. G06T 11/60

(52) U.S. Cl. CPC G06T 11/60; G06T 2200/24

(57) ABSTRACT

Provided is a storage medium storing a control method to be executed by an information processing apparatus, the method including: displaying a screen including an editing region in which data is editable, on a display unit, the data being data in which one or more image objects are placed; and receiving selection of one image object in a layout displayed in the editing region, in which a thumbnail display region to display a thumbnail is displayable on the screen, and in which the displaying includes performing control to display a thumbnail of a layout obtained by replacing the one image object with a thumbnail of an image content available for an application in the thumbnail display region in response to receiving selection of the one image object in the receiving.

### BACKGROUND

### Field of Technology

The present disclosure relates to a storage medium, an information processing apparatus, and a method of controlling an information processing apparatus.

### Description of the Related Art

In designing of products such as posters, there is a demand to use a design creation application to create designs. The design creation process may involve an operation of adding an image to be placed in the design data or an operation of replacing an image with another. In a case of replacing an image with another, a technique called variable data printing is used in which replacement images and designs are prepared, and designs in which the image is replaced are generated and printed in the same number as the replacement images (see Japanese Patent Laid-Open No. 2009-110391).

There is a demand to reduce the burden on the user in layout editing.

### SUMMARY

A storage medium according to the present disclosure is a non-transitory computer readable storage medium storing a program which causes a computer to execute a method of controlling an information processing apparatus, and the method includes: displaying a screen including an editing region in which data is editable, on a display unit, the data being data in which one or more image objects are placed; and receiving selection of one image object in a layout displayed in the editing region, in which a thumbnail display region to display a thumbnail is displayable on the screen, and in which the displaying includes performing control to display a thumbnail of a layout obtained by replacing the one image object with a thumbnail of an image content available for an application in the thumbnail display region in response to receiving selection of the one image object in the receiving.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a system;

FIG. 2 is a hardware configuration diagram of a client personal computer (PC) in an embodiment;

FIG. 3 is a functional block diagram of the client PC in the embodiment;

FIG. 4 is a diagram illustrating an embodiment of the system;

FIG. 5 is a diagram illustrating an embodiment of the system;

FIG. 6 is a diagram illustrates a flowchart for the system;

FIG. 7 is a diagram illustrating an embodiment of the system;

FIG. 8 is a diagram illustrating an embodiment of the system;

FIG. 9 is a diagram illustrates a flowchart for the system;

FIG. 10 is a diagram illustrating an embodiment of the system;

FIG. 11 is a diagram illustrating an embodiment of the system; and

FIG. 12 is a diagram illustrates a flowchart for the system.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with "S".

### First Embodiment

On a layout editing application, an image may be added to a currently edited design or an image in the currently edited design may be replaced. In this case, the user finds multiple images similar to a desired image from among a large number of images, actually adds an image or replaces an image with another, and then checks whether the whole design with the image appears as a desired design. In a case where the user determines that it is not the desired design, the user needs to perform an operation of replacing the image with another. That is, the user needs to repeat the operation of finding multiple images similar to the desired image from among the large number of images, actually adding an image or replacing an image with another, and then checking whether the whole design with the image appears as the desired design. Thus, checking whether the whole design is the desired design is imposes a large work load on the user. There is a demand to reduce the burden on the user in layout editing. In the following, a technique capable of reducing the burden on a user in layout editing will be described.

### Information Processing Apparatus

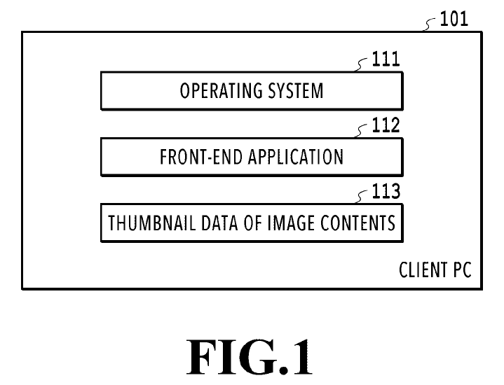

First, the description will be given with reference to block diagrams of an information processing apparatus (client PC) in the present embodiment illustrated in FIGS. 1 to 3. Also, the present embodiment will be described taking the following configurations as an example but is not limited to the functions illustrated in those diagrams. For example, the information processing apparatus is not limited to a PC. The information processing apparatus may be a laptop PC, a tablet, or a smartphone.

FIG. 1 is a configuration diagram of a system. The system includes a client PC 101. The client PC 101 includes an operating system 111, a front-end application 112, and a thumbnail data 113 of image contents. Note that the thumbnail data 113 of image contents is included in the client PC 101, but may be in a server or a different client PC.

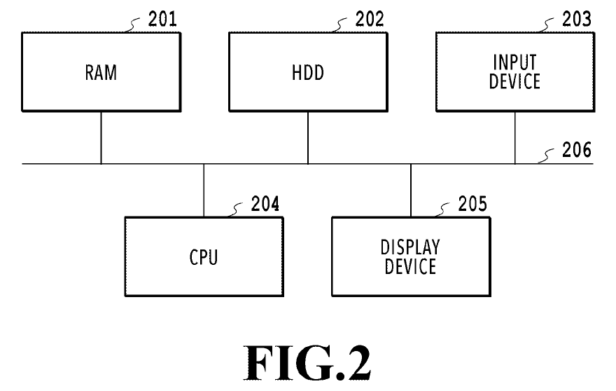

FIG. 2 is a diagram illustrating an example of a hardware configuration of the client PC 101 in the present embodiment. As illustrated in FIG. 2, the client PC 101 includes a random-access memory (RAM) 201, a hard disk drive (HDD) 202, an input device 203 including a keyboard, and a central processing unit (CPU) 204. Also, the client PC 101 further includes a display device 205 as a display monitor (display unit), and a bus 206 by which the above devices are communicably connected. Note that the HDD 202, which is a storage unit, may be a solid-state drive (SSD), a flash memory, or a cloud storage. Also, the storage unit may include a portable compact disc (CD)-ROM, a built-in ROM, and so on. Further, in a case where the system includes a server as its component, a network board may be included as a hardware component. Also, a touch panel including the input device 203 and the display device 205 may be used.

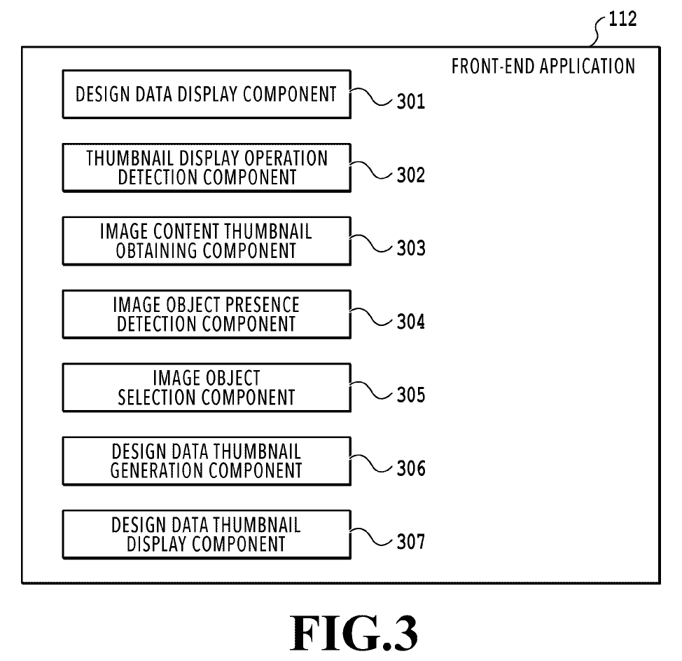

FIG. 3 is a diagram illustrating an example of a configuration of the front-end application 112 in the present embodiment. The front-end application 112 includes a design data display component 301, a thumbnail display operation detection component 302, an image content thumbnail obtaining component 303, an image object presence detection component 304, and an image object selection component 305. The front-end application 112 also includes a design data thumbnail generation component 306 and a design data thumbnail display component 307.

The design data display component 301 displays design data in an editing region. The thumbnail display operation detection component 302 detects user operations on a thumbnail display region. The image content thumbnail obtaining component 303 obtains the thumbnail data 113 of image contents available to the user. The image object presence detection component 304 detects that the design data includes one or more image objects. The image object selection component 305 detects selection of one image object included in the design data. In other words, the image object selection component 305 functions as a reception component that receives selection of an image object. The design data thumbnail generation component 306 generates thumbnails of the design data in which the selected image object is replaced with the thumbnail of an image content. The design data thumbnail display component 307 displays the generated thumbnails of the design data in matrix in the thumbnail display region. Details of each component (unit) will be described later. The following description will be given using an example in which the front-end application 112 is poster creation software 400.

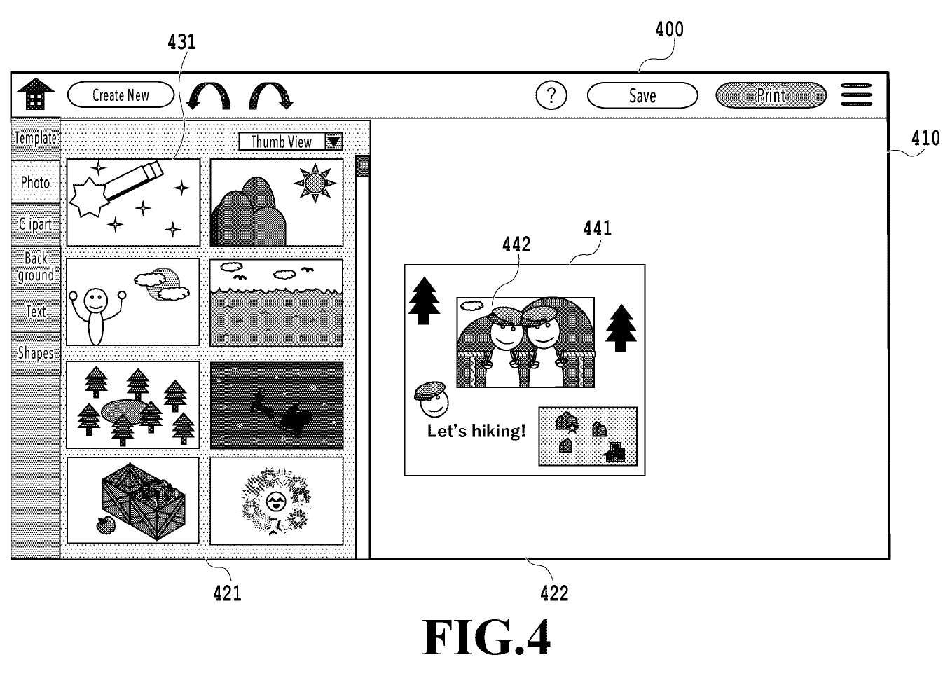

FIG. 4 is a diagram illustrating an example of an editing screen 410 of the poster creation software 400. The editing screen 410 of the poster creation software 400 includes a thumbnail display region 421 and an editing region 422. That is, the thumbnail display region 421 and the editing region 422 can be displayed on the editing screen 410. Here, the thumbnail display region 421 can be hidden. Also, the display of the editing screen 410 is controlled by the CPU 204. In the editing region 422, editable design data 441 is displayed. The design data 441 includes an image object 442. In the thumbnail display region 421, the thumbnail data 113 of image contents obtained by the design data thumbnail generation component 306 are displayed in matrix. Thumbnails 431 are thumbnail images of the thumbnail data 113 of the image contents obtained by the design data thumbnail generation component 306. The user selects the image object 442 by performing a click on the image object 442 in order to replace the image of the image object 442. Note that the operation of select the image object 442 is not limited to performing a click, and the image object 442 may be selected by a different operation, such as double-clicking.

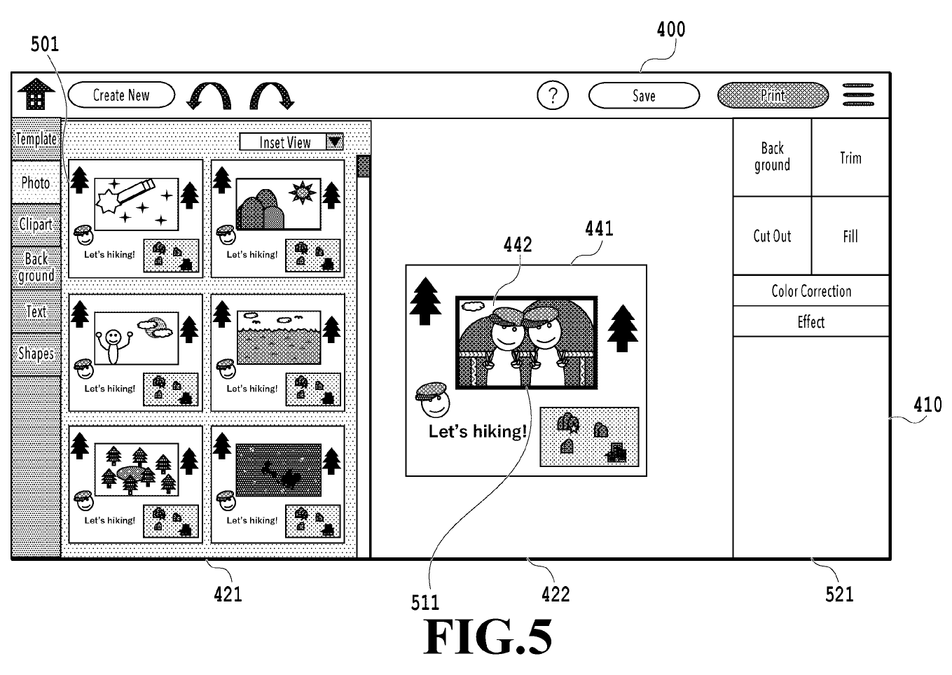

FIG. 5 is a diagram in which thumbnails 501 of design data in which the image object 442 is replaced with the thumbnail data 113 of an image content are displayed in the thumbnail display region 421 after the user changes the state of the image object 442 to a selected state. An object frame 511 indicating the image object 442 is selected is displayed around the image object 442. In the thumbnail display region 421, the thumbnails 501 of the design data in which the selected image object 442 is replaced with the thumbnail data 113 of an image content are displayed.

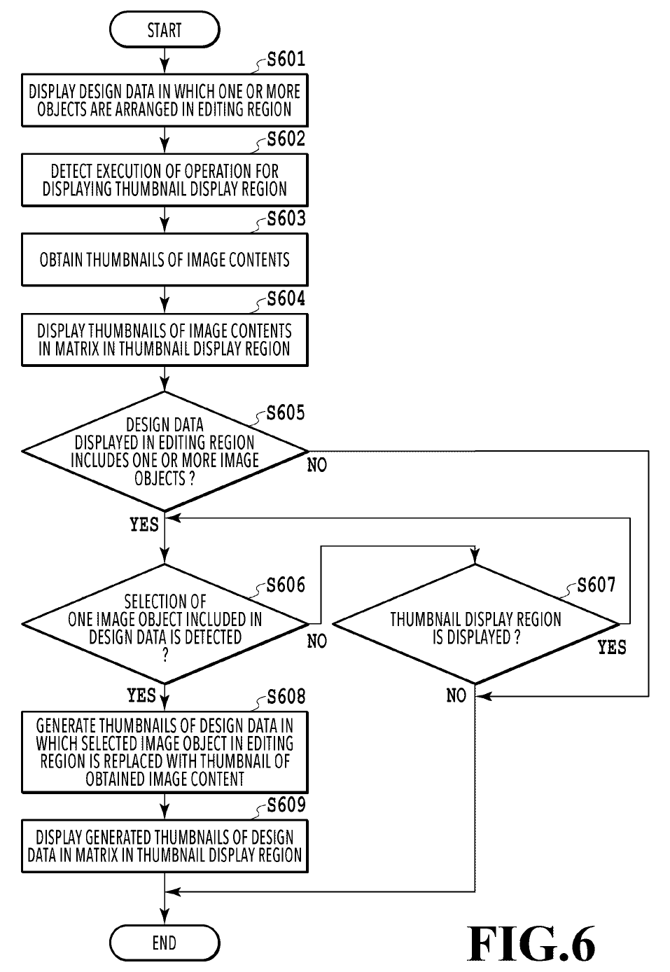

FIG. 6 is a flowchart illustrating a sequence of processing executed by the front-end application 112 in the present embodiment. Each process illustrated in FIG. 6 is implemented by the CPU 204 of the client PC 101 loading the program of the front-end application 112 stored in the HDD 202 into the RAM 201 and launching the front-end application 112. In this section, a description will be given using the poster creation software 400 as an example of the front-end application 112.

In S601, the CPU 204 launches the poster creation software 400 and displays currently edited design data 441 including one or more image objects 442 in the editing screen 410. After the currently edited design data 441 is displayed, the processing proceeds to S602. In S602, the CPU 204 detects a user operation for displaying the thumbnail display region 421, and the processing proceeds to S603. In S603, the CPU 204 obtains thumbnail data 113 of image contents, and the processing proceeds to S604. In S604, the CPU 204 displays the obtained thumbnail data 113 of the image contents in the thumbnail display region 421, and the processing proceeds to S605.

In S605, the CPU 204 determines whether the design data 441 displayed in the editing region 422 has been detected to include one or more image objects. In a case where the CPU 204 determines that the design data 441 includes one or more image objects, the processing proceeds to S606. In a case where the CPU 204 determines that the design data 441 includes no image object, the processing in the flowchart illustrated in FIG. 6 is finished.

In S606, the CPU 204 determines whether it has received selection of one image object 442 included in the design data 441. In a case where the CPU 204 determines that it has received selection of one image object 442 included in the design data 441, the processing proceeds to S608. In a case where the CPU 204 determines that it has not received selection of an image object included in the design data 441, the processing proceeds to S607.

In S607, the CPU 204 determines whether the thumbnail display region 421 is displayed. In a case where the CPU 204 determines that the thumbnail display region 421 is displayed, the processing returns to S606. In a case where the CPU 204 determines that the thumbnail display region 421 is not displayed, the processing in the flowchart illustrated in FIG. 6 is finished.

In S608, the CPU 204 generates thumbnails 501 of design data in which the selected image object 442 in the editing region 422 is replaced with the thumbnail data 113 of an image content obtained in S603. After the thumbnails 501 of the design data are generated, the processing proceeds to S609. In S609, the CPU 204 displays the thumbnails 501 of the design data generated in S608, in matrix, in the thumbnail display region 421. After the thumbnails 501 of the design data are displayed in matrix in the thumbnail display region 421, the processing in the flowchart illustrated in FIG. 6 is finished.

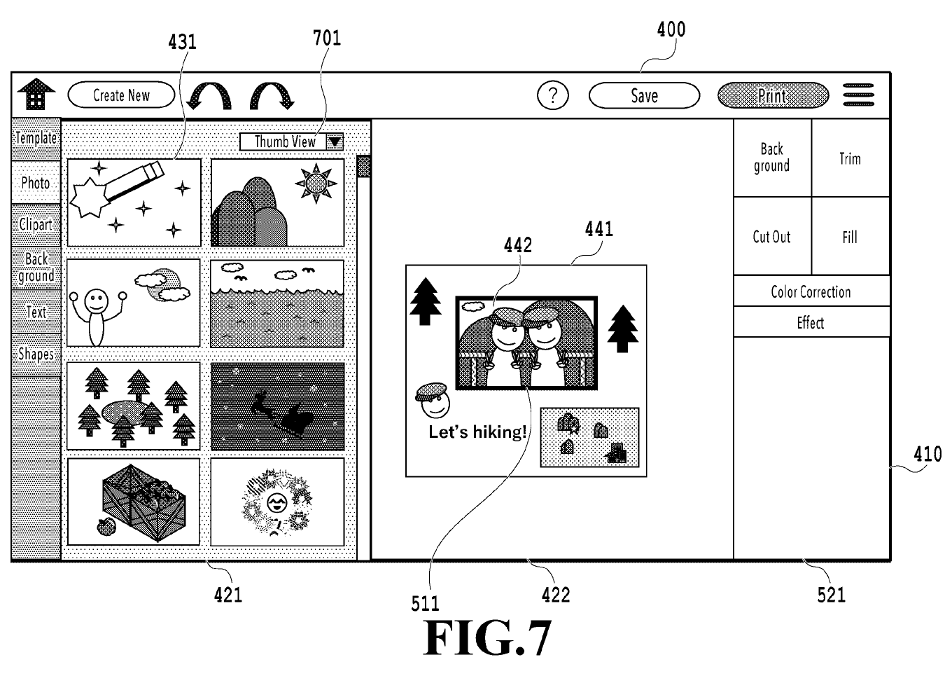

Note that, in the present embodiment, in a case where one image object is selected in the process of S606, the CPU 204 displays the thumbnails 501 of the design data generated in S608 in matrix in the thumbnail display region 421. Alternatively, after the thumbnails 501 of the design data are displayed in the thumbnail display region 421, the contents displayed in the thumbnail display region 421 may be switched in response to a user operation. For example, in a case of switching the display in the thumbnail display region 421 to thumbnail data 113 of image contents obtained in response to a user operation, the following process is executed. After executing the process of S609, the CPU 204 executes the processes of S603 and S604, so that the thumbnail data 113 of the image contents obtained in S603 are displayed in the thumbnail display region 421. One example of the user operation may be selecting a display setting in a display switching pull-down menu 701 illustrated in FIG. 7, but the user operation is not limited to this. For example, a button-operated menu may be displayed, and thumbnail data 113 of image contents obtained in S603 in response to receiving a press on a button may be displayed in the thumbnail display region 421.

Also, in the present embodiment, in a case where thumbnail data 113 of image contents are not displayed in the thumbnail display region 421 before receiving selection of one image object 442, the following process may be executed in response to receiving selection of one image object. After receiving selection of one image object, the CPU 204 does not display thumbnails of design data 441 in which the one image object is replaced with the thumbnail data 113 of an image content in the thumbnail display region.

Also, for thumbnail display in the thumbnail display region 421, the following process may be performed. In a state where the thumbnail display region 421 is not displayed on the editing screen 410, the CPU 204 receives selection of one image object from the design data 441 displayed in the editing region 422. After receiving selection of the one image object, the CPU 204 obtains thumbnail data 113 of image contents based on a user operation. In response to receiving display of the thumbnail display region 421 based on a user operation, the CPU 204 executes the following display process. Specifically, the CPU 204 displays thumbnails of design data 441 in which the one image object 442 is replaced with the thumbnail data 113 of an image content in the thumbnail display region 421.

According to the technique of the present embodiment, versions of currently edited design data whose image object is replaced with an obtained image content can collectively checked. This reduces the burden on the user in layout editing.

### Second Embodiment

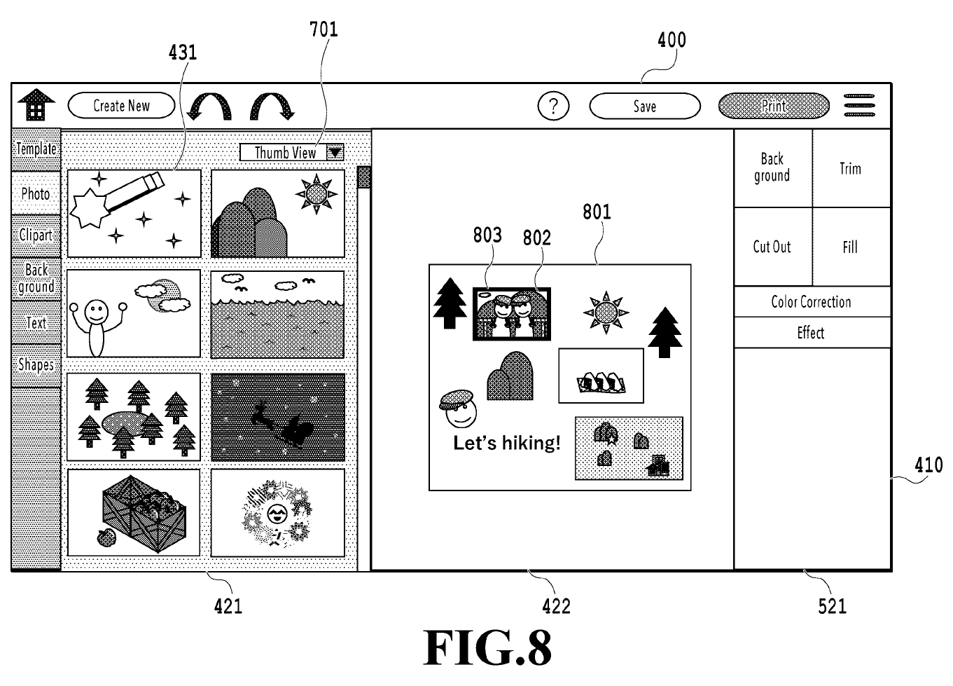

In the first embodiment, an example has been shown in which the thumbnails of the design data obtained by replacing the selected image object with the thumbnail of the image content are displayed in matrix irrespective of the type of the image object. In the present embodiment, an example will be presented in which, for an image object of such a size that the ratio of its area to the area of the design data is less than a predetermined ratio, thumbnails of image contents are displayed in matrix instead of thumbnails of design data. Specifically, as illustrated in FIG. 8, for design data 801 that includes an image object 802 significantly smaller than the design data 801, thumbnails 431 of image contents are displayed in matrix in the thumbnail display region 421.

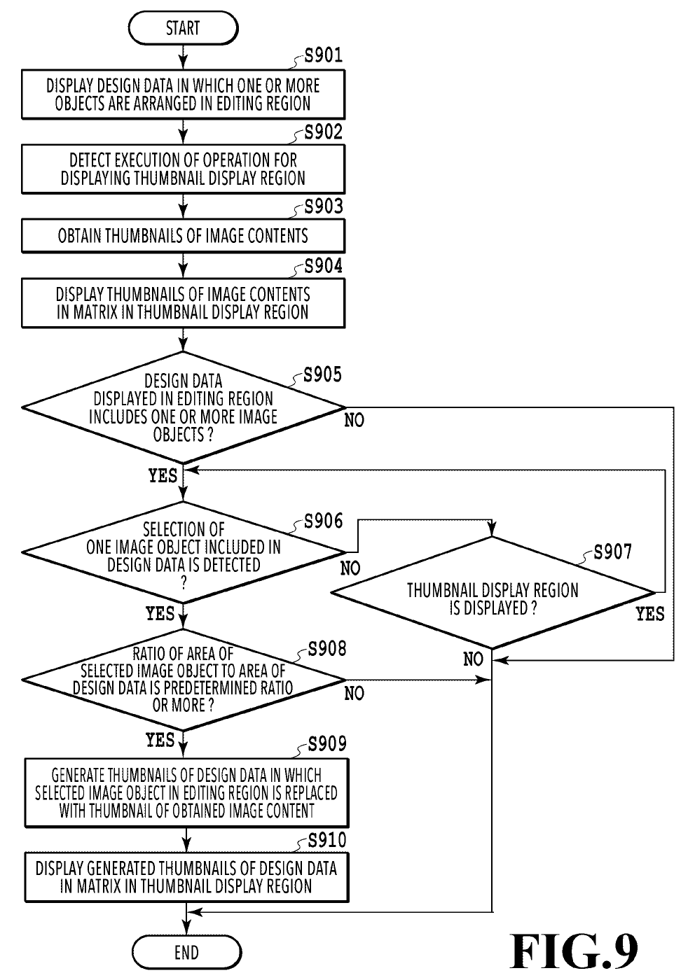

FIG. 9 is a flowchart illustrating a sequence of processing executed by the front-end application 112 in the present embodiment. Each process illustrated in FIG. 9 is implemented by the CPU 204 of the client PC 101 loading the program of the front-end application 112 stored in the HDD 202 into the RAM 201 and launching the front-end application 112. In this section, a description will be given using the poster creation software 400 as an example of the front-end application 112.

The processes S901 to S907 are the same as the processes of S601 to S607 in the first embodiment, and description thereof will therefore be omitted. If the CPU 204 determines in S906 that one image object has been selected, the processing proceeds to S908. In S908, the CPU 204 determines whether or not the ratio of the area of the selected image object 802 to the area of the design data 801 is a predetermined ratio or more. In a case where the ratio of the area of the image object 802 selected in S906 to the area of the design data 801 is the predetermined ratio or more, the processing proceeds to S909. In a case where the ratio of the area of the image object 802 selected in S906 to the area of the design data 801 is less than the predetermined ratio, the processing in the flowchart illustrated in FIG. 9 is finished.

In S909, the CPU 204 generates thumbnails 501 of design data in which the selected image object 802 in the editing region 422 is replaced with the thumbnail data 113 of an image content obtained in S903. After the thumbnails 501 of the design data are generated, the processing proceeds to S910. In S910, the CPU 204 displays the thumbnails of the design data generated in S909, in matrix, in the thumbnail display region 421. After the thumbnails of the design data are displayed in matrix in the thumbnail display region 421, the processing in the flowchart illustrated in FIG. 9 is finished.

Note that, in the present embodiment, the numerical value of the above-described predetermined ratio is a predetermined value on the system side (e.g., 20% or 30%), but is not limited to this. A setting component that sets the above-described predetermined ratio based on a user operation may be provided, and a value input into the setting component by the user may be set as the numerical value of the above-described predetermined ratio. As described above, according to the technique of the present embodiment, it is possible to prevent a deterioration in the visibility of the thumbnails of the image contents in the thumbnail display region due to displaying them in a size smaller than a predetermined size, and avoid an increase in the work load on the user.

### Third Embodiment

In the first and second embodiments, examples have been presented in which image object replacement is performed in a situation where a selected image object is present. In the present embodiment, an example will be presented in which the display of thumbnails is switched in a case of adding an image to design data in a state where no image object is selected.

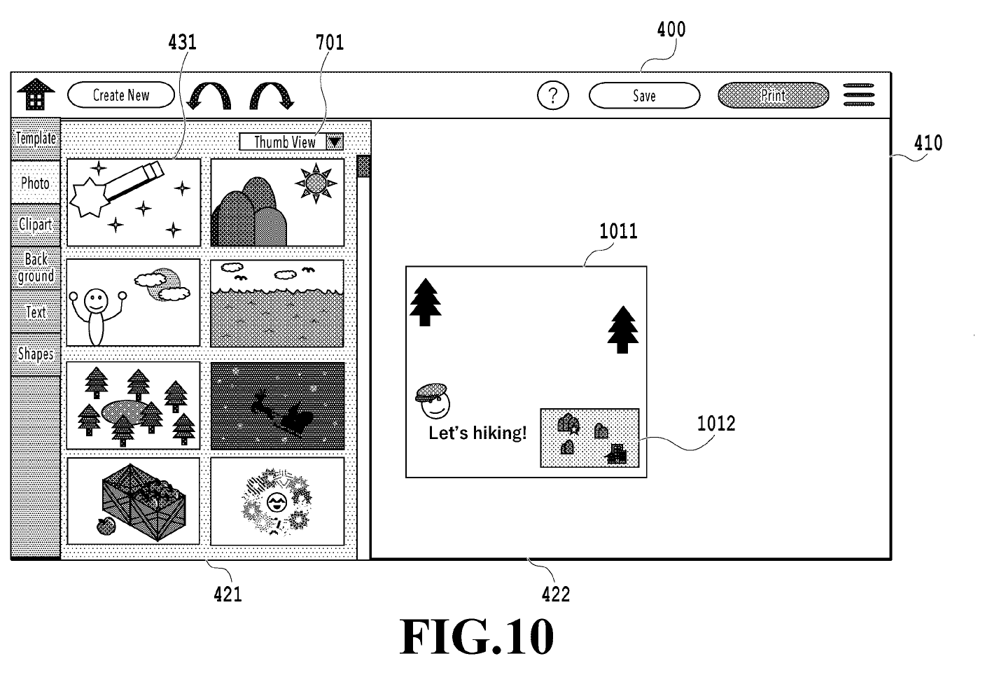

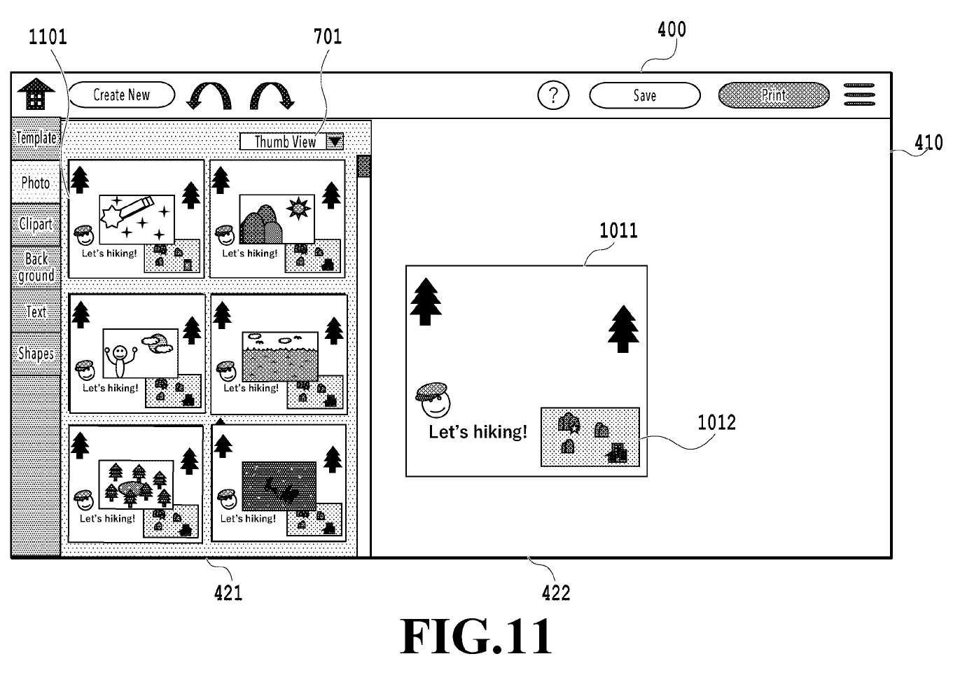

FIG. 10 illustrates the editing screen 410 on which design data 1011 with an image object in a state where the image object is not selected is displayed in the editing region 422. FIG. 11 illustrates an example in which the display switching pull-down menu 701 in the thumbnail display region 421 is switched from a thumbnail display setting (Thumb View) to an inset display setting (Inset View) in which an image is inset into a designated region. Illustrated is an example of the editing screen 410 on which thumbnails 1101 of design data obtained adding the thumbnail data 113 of an image content to the center of the design data 1011 are displayed in the thumbnail display region 421 in FIG. 11.

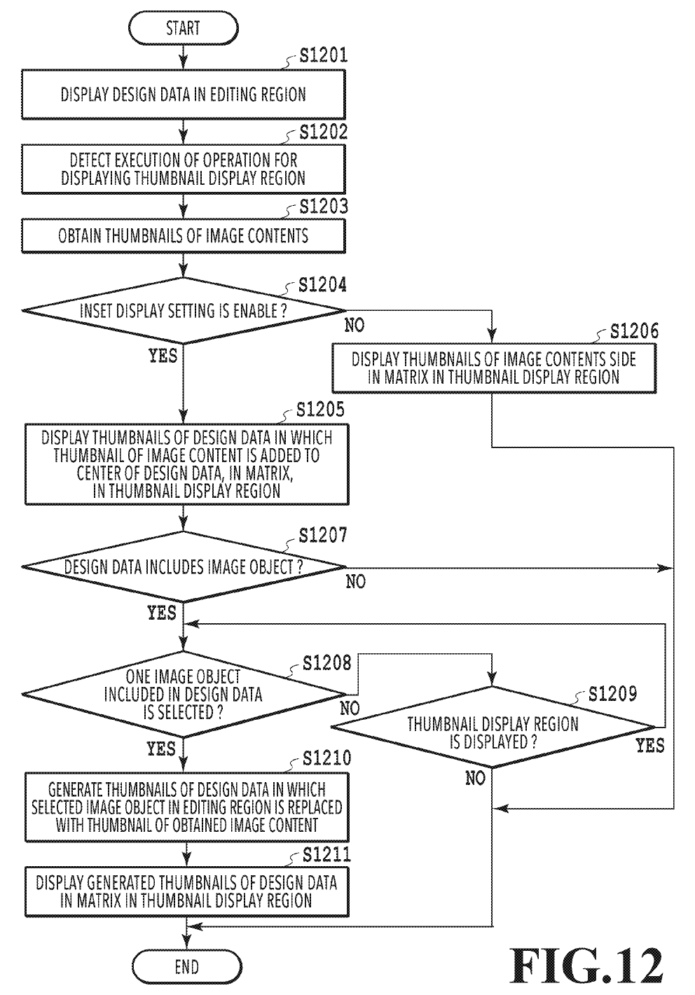

FIG. 12 is a flowchart illustrating a sequence of processing performed by the front-end application 112 in the present embodiment. Each process illustrated in FIG. 12 is implemented by the CPU 204 of the client PC 101 loading the program of the front-end application 112 stored in the HDD 202 into the RAM 201 and launching the front-end application 112. In this section, a description will be given using the poster creation software 400 as an example of the front-end application 112.

In S1201, the CPU 204 launches the poster creation software 400 and displays currently edited design data 1011 in the editing screen 410. After the currently edited design data 1011 is displayed, the processing proceeds to S1202. In S1202, the CPU 204 detects a user operation for displaying the thumbnail display region 421, and the processing proceeds to S1203. In S1203, the CPU 204 obtains thumbnail data 113 of image contents, and the processing proceeds to S1204.

In S1204, the CPU 204 determines whether the inset display setting for insetting an image into a designated region is enabled in the display switching pull-down menu 701. In a case where the CPU 204 determines that the inset display setting is enabled in the display switching pull-down menu 701, the processing proceeds to S1205. In a case where the CPU 204 determines that the inset display setting is not enabled in the display switching pull-down menu 701, the processing proceeds to S1206.

In S1205, the CPU 204 displays thumbnails of design data 1011 obtained by adding the thumbnail of an image content to the center of the design data 1011, in matrix, in the thumbnail display region 421. After the thumbnails of the design data 1011 are displayed in matrix in the thumbnail display region 421, the processing proceeds to S1207. In S1206, the CPU 204 displays the thumbnail data 113 of the image contents obtained in S1203, in matrix, in the thumbnail display region 421. After the thumbnail data 113 of the image contents are displayed in matrix in the thumbnail display region 421, the processing in the flowchart illustrated in FIG. 12 is finished.

In S1207, the CPU 204 determines whether the design data 1011 has been detected to include one or more image objects. In a case where the CPU 204 determines that the design data 1011 includes one or more image objects, the processing proceeds to S1208. In a case where the CPU 204 determines that the design data 1011 includes no image object, the processing in the flowchart illustrated in FIG. 12 is finished.

In S1208, the CPU 204 determines whether it has received selection of one image object 1012 included in the design data 1011. In a case where the CPU 204 determines that it has received selection of one image object 1012 included in the design data 1011, the processing proceeds to S1210. In a case where the CPU 204 determines that it has not received selection of an image object included in the design data 1011, the processing proceeds to S1209.

In S1209, the CPU 204 determines whether the thumbnail display region 421 is displayed. In a case where the CPU 204 determines that the thumbnail display region 421 is displayed, the processing returns to S1208. In a case where the CPU 204 determines that the thumbnail display region 421 is not displayed, the processing in the flowchart illustrated in FIG. 12 is finished.

In S1210, the CPU 204 generates thumbnails of design data in which the selected image object 442 in the editing region 422 is replaced with the thumbnail data 113 of an image content obtained in S1203. After the thumbnails of the design data are generated, the processing proceeds to S1211. In S1211, the CPU 204 displays the thumbnails of the design data generated in S1210, in matrix, in the thumbnail display region 421. After the thumbnails of the design data are displayed in matrix in the thumbnail display region 421, the processing in the flowchart illustrated in FIG. 12 is finished.

Note that the present embodiment has been described using the design data 1011 including an image object as an example, but is not limited to this. Design data including no image object may be used. Also, the thumbnail data 113 of an image content is placed at the center of the design data 1011 in S1205, but the present embodiment is not limited to this. For example, the position to place the thumbnail data 113 may be set at a position designated by a user operation.

As described above, in a case of adding an image to design data, it is possible to collectively check versions of currently edited design data to which an image is added by using thumbnails. This reduces the burden on the user in layout editing.

The technology according to the present disclosure improves usability of date printing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-077274, filed May 7, 2025, which is hereby incorporated by reference herein in its entirety.

What is claimed is:

1. A non-transitory computer readable storage medium storing a program which causes a computer to execute a method of controlling an information processing apparatus, the method comprising:
displaying a screen including an editing region in which data is editable, on a display unit, the data being data in which one or more image objects are placed; and
receiving selection of one image object in a layout displayed in the editing region,
wherein a thumbnail display region to display a thumbnail is displayable on the screen, and
wherein the displaying includes performing control to display a thumbnail of a layout obtained by replacing the one image object with a thumbnail of an image content available for an application in the thumbnail display region in response to receiving selection of the one image object in the receiving.

2. The storage medium according to claim 1, wherein the displaying includes
displaying the thumbnail of the image content available for the application in the thumbnail display region before receiving selection of the one image object in the receiving, and
switching from displaying the thumbnail of the image content to displaying the thumbnail of the layout obtained by replacing the one image object with the thumbnail of the image content after receiving selection of the one image object in the receiving.

3. The storage medium according to claim 1, wherein the displaying includes not displaying the thumbnail of the layout obtained by replacing the one image object with the thumbnail of the image content available for the application in the thumbnail display region after receiving selection of the one image object in the receiving in a case where the thumbnail of the image content is not displayed in the thumbnail display region before receiving selection of the one image object in the receiving.

4. The storage medium according to claim 1, wherein the displaying includes displaying the thumbnail of the layout obtained by replacing the one image object with the thumbnail of the image content available for the application in the thumbnail display region after receiving selection of the one image object in the receiving in a case where the thumbnail display region is not displayed.

5. The storage medium according to claim 1, wherein the displaying includes performing the control in a case where a ratio of an area of the one image object selection of which is received in the receiving to an area of the layout in the editing region is a predetermined ratio or more.

6. The storage medium according to claim 1, wherein the displaying includes not performing the control in a case where a ratio of an area of the one image object selection of which is received in the receiving to an area of the layout in the editing region is less than a predetermined ratio.

7. The storage medium according to claim 5, wherein the method further comprises setting the predetermined ratio via a user operation.

8. The storage medium according to claim 1, wherein the displaying includes performing the control to display in the thumbnail display region a thumbnail of a layout obtained by placing the thumbnail of the image content available for the application at a predetermined position in the layout in a case where a display setting of the thumbnail display region is a display setting for insetting an image into a designated region.

9. The storage medium according to claim 8, wherein the predetermined position is a center of the layout.

10. The storage medium according to claim 1, wherein the displaying further includes switching display in the thumbnail display region to the thumbnail of the layout or to the thumbnail of the image content via a user operation after the control.

11. The storage medium according to claim 10, wherein the switching of the display is pressing a predetermined button displayed on the display unit.

12. An information processing apparatus comprising one or more processors and/or circuitry which function as:
a display control unit configured to display a screen including an editing region in which data is editable, on a display unit, the data being data in which one or more image objects are placed; and
a reception unit configured to receive selection of one image object in a layout displayed in the editing region,
wherein a thumbnail display region to display a thumbnail is displayable on the screen, and
wherein the display control unit performs control to display a thumbnail of a layout obtained by replacing the one image object with a thumbnail of an image content available for an application in the thumbnail display region in response to the reception unit receiving selection of the one image object.

13. A method of controlling an information processing apparatus, the method comprising:
displaying a screen including an editing region in which data is editable, on a display unit, the data being data in which one or more image objects are placed; and
receiving selection of one image object in a layout displayed in the editing region,
wherein a thumbnail display region to display a thumbnail is displayable on the screen, and
wherein the displaying includes performing control to display a thumbnail of a layout obtained by replacing the one image object with a thumbnail of an image content
available for an application in the thumbnail display region in response to receiving selection of the one image object in the receiving.
